(19) United States
(12) Patent Application Publication
(10) Pub. No.: US 2009/0016944 A1
(43) Pub. Date: Jan. 15, 2009

(54) Hydrogen generator, Carbon dioxide and sulfate captor

(75) Inventor: Denyse Claire DuBrucq, Cedarville, OH (US)

Correspondence Address: Denyse DuBrucq, 100 W. Elm Street, Cedarville, OH, 45314-8575, US

(73) Assignee: Air Wars Defense LP, Cedarville, OH (US)

(21) Appl. No.: 11/825,992

(22) Filed: Jul. 10, 2007

(51) Int. Cl. B01D 53/34; B01D 53/48; C01B 3/08; C01B 5/00; C01F 1/00

(52) U.S. Cl. 423/157; 423/212; 423/242.1; 423/580.1; 423/657

(57) ABSTRACT

This invention provides a means to produce on site Hydrogen to power fuel cells or Hydrogen engines storing the energy in Calcium metal. It continues by using the Calcium hydroxide byproduct of Calcium generated Hydrogen reaction to capture Carbon dioxide from exhaust situations, both moving and stationary as trucks and power plants. This reaction goes to completion with the sedimentation of Calcium carbonate, which may be useful to the cement industry as a component of their products, or it could be used to capture sulfates in stack gas. Either Calcium carbonate or Calcium sulfate may be electrolyzed to recover metallic Calcium, which is not readily available on the market at this time. Solar power, water wheels, resistive gym apparatus, wind power generation of electrical energy as well as unused power from power plants can electrolyze water into Hydrogen and Oxygen. The Hydrogen is passed through and over Calcium carbonate freeing the Calcium as pure metal and releasing as gases water and Carbon dioxide, which, if fed into a greenhouse, will make plants grow rapidly and during daylight, release heavily Oxygenated air from the greenhouse environment. Oxygen can be sold to health, scuba and industrial businesses. These reactions are commercially feasible making Hydrogen propulsion as with a Hydrogen piston engine and fuel cell driving for generating power safer because large amounts of Hydrogen do not have to be carried or on hand during use or down times. Replaceable vessels for both Hydrogen generation and Carbon dioxide capture systems provide viable options for both transportation and stationary Hydrogen consumption applications.

### BACKGROUND

Hydrogen as a molecule, H₂, comprises 0.2% of the atmospheric gas throughout the earth. It is volatile. When mixed with Oxygen, another molecule, O₂, it explodes forming water H₂O. The clean burn makes it an ideal fuel for vehicles. However, storage of Hydrogen leaves opportunities for explosion, requires strong walled cylinders for the compressed gas, which leaks through the materials of most containers, and, as with the Hindenberg, leaves the vehicle vulnerable to explosion from electrical charges as lightning and static electricity.

Rather than carrying the kilograms of Hydrogen on the vehicle, one could generate Hydrogen onboard the vehicle. Forming Hydrogen from Electrolysis from water takes too much power to efficiently carry this out, but dropping a mass of Calcium metal in water produces Hydrogen in an instant in selectable quantities.

Over the years, DuBrucq has shown students an experiment that lets them experience elements, molecules, reactions that run to completion, pH changes, speed of reaction, solution, precipitation, states of matter, and to top it off how fossils form. It is relevant to this effort because the initial reaction places Calcium (Ca) metal from a long term stored reagent bottle into water (H₂O). The apparatus contains water and Calcium shavings in a test tube with a stopper with one hole. A tube in that hole goes from that hole to an inverted stopper with two holes onto which an inverted test tube is placed. The second hole in the upper stopper has a tube at the surface of the stopper inside the test tube and extending out to vent into the atmosphere. The Calcium metal surface reacts with the water producing bubbles, which rise to the water surface. In a minute or so, one can remove the inverted tube, keeping it inverted and replace it with another. Then with a match, light a splint and blow out the flame. Insert the glowing splint into the inverted test tube. “BOOOOK”, a reaction occurs leaving water droplets on the inner walls of the test tube.

What happened? Calcium reacted with water forming Ca(OH)₂ and H₂, Calcium hydroxide and Hydrogen. Testing the pH of the water before the Calcium is added and after the reaction has run, the liquid is changed from neutral pH 7 to basic. pH 13. The reaction of a solid plus a liquid has resulted in a chemical solution of Calcium hydroxide in the water causing the pH change and permanent escape of Hydrogen gas.

The gas molecule H₂, Hydrogen, combined with another gas molecule in the air, O₂, Oxygen, and the “BOOOOK” indicates the speed of reaction was immediate, quick. Compared with the speed of reaction of the old reagent Calcium and water combination, it was instantaneous. Did this reaction go to completion? Yes. How can one tell? The reaction formed water, H₂O, which appears as a liquid on the walls of the inverted test tube. It can be vapor, and it can precipitate to fog combining to form full droplets and cling to the test tube walls. In the case of a fuel cell using the hydrogen, the output is the desirable, clean, pure water. The same byproduct occurs when using Hydrogen in a combustion engine rather than gasoline, ethanol, diesel fuel, jet fuel or kerosene. All these hydrocarbons burned in engines give off hydrocarbons and Carbon dioxide.

The solution of Calcium hydroxide in water gives a basic solution, high pH. When the reaction is completed, place a straw or glass tube into the solution. Have someone gently blow bubbles in the solution. Check the pH. And watch the solution. Upon completion of this reaction, the pH is returned to 7, neutral, and the dissolved Calcium component is now sediment in the bottom of the test tube. What happened? Ca(OH)₂ and CO₂ from one's breath combined forming Ca(CO₃)₂ and H₂O. The Calcium carbonate separated out as a precipitate or sediment leaving the water pure with a neutral pH.

To get a bit archeological, if one tosses a mosquito into the test tube as the sediment settles, one gets the initial stages of fossil formation. Kids love this part.

The invention here applies these reactions specifically where the end product is needed for Hydrogen fuel cells and applies the Calcium hydroxide to dispose of Carbon dioxide in exhaust where that occurs. It is water in and water out in both the combustion of Hydrogen and Oxygen and in Calcium hydroxide capture of Carbon dioxide. And the sediment can be sold to cement factories for roads and sidewalks, buildings and support walls. Or it could be used in a reduction reaction in a sealed atmosphere where generated Hyrdogen is passed over the Calcium carbonate or Calcium hydroxide releasing the metal Calcium and setting free either Carbon dioxide or water which must be trapped by a severely cold getter or water trap to pull it from the reversible reaction. The apparatus for this reaction is referred to as a reduction chamber. Two types are proposed in this patent.

Recent demonstrations of the experiment used a new bottle of the reagent Calcium that came in a wax sealed jar in a sealed can. Using water displacement from an inverted 250 ml graduated cylinder to catch the Hydrogen, when 0.5 gram of the Calcium was dropped in the water, the reaction went to completion instantaneously leaving the water converted to a concentrated solution of Calcium hydroxide and 250 ml of gaseous Hydrogen displacing the water. Repeating the experiment with the new Calcium, this time using gas displacement of an inverted glass vase over the water-Calcium reaction, run to completion, upon tipping the vase about 15 degrees from inverted vertical, a spontaneous explosion happened during both tries leaving a ring of water condensed in the vase in a region of the cylinder about four inches from the base of the inverted vase. Also, watching the reaction, some six to eight inches outside the vase neck, radiating red lines were seen extending outward centered from the vase opening. These red spectral lines were about two inches long. Observers of the Hindenberg explosion reported they saw red emissions from the explosion. Since red emissions are not among the strong lines of Hydrogen stated the commentary from the PBS special on the Hindenberg explosion, observers' reports were discounted. Since these lines emerged from the Oxygen source region of the air, not the Hydrogen source, which would have been in the vase, the lines are most likely from breaking apart the Oxygen molecule or light emitted in water formation. The placement of the water from the explosion inside the vase indicates a gas volume compression to the liquid/vapor water volume being several inches from the vase opening indicates the spacial compression of the reaction.

The equation for these reactions start with Calcium, MW 40.08, displacing two Hydrogen atoms, MW 2, in the Hydrogen releasing reaction so the weight ratio for vehicle bearing is 20.04 gm of Calcium produces a gram of Hydrogen molecules for fuel using 36 grams of water, MW 18, using two atoms plus 20% more water to allow residual water to make the Calcium hydroxide solution. Ingredient weights for the reaction are 20.04 kg Ca and 43.2 kg water for each kilogram of Hydrogen, generated as needed, a ratio of 63.6:1. Recoverable water from H₂ combustion is 9 kg., drinking water for a day. If the driver using Hydrogen requires 1 kg H₂ for every 25 miles, 763.2 kg of reagents must be on board for a 300 mile excursion. It is not recommended for aircraft.

Compare this with the weight of the Hydrogen tank to contain compressed Hydrogen. New types of compressed gas containers for Hydrogen are still too heavy to carry sufficient Hydrogen for 300 miles of travel before refueling according the NREL R&D as reported in a web search for mass added for carrying Hydrogen. According to Michael Heben at NREL, graphite containers are 10× the weight of the gas compressed within them. DOE requires 2.5× the PSI testing for these units so 10,000 PSI containers, usually spherical, must withstand 25,000 PSI pressure to be allowed for vehicular use.

Another aspect of the invention relates to a method of purifying large quantities of Calcium metal anticipating its use in generating Hydrogen onboard electric vehicles for both fuel cell use and Hydrogen fueled engines. Because Calcium metal has no trade applications and is semi-reactive, little effort has been put forth to prepare it in quantities regardless of its abundance in nature in molecular configurations. Generating Hydrogen fuel as needed rather than carrying a supply in compressed air tanks can improve the safety of future vehicles. It can be termed “cold cracking Calcium.”

### PRIOR ART DISCUSSION

Generation of Hydrogen by metal hydrolysis at the point of use is a replacement for hydrogen storage onboard vehicles. This idea is not novel or without significant engineering and economic hurdles. A system similar to the Calcium system is supposedly in operation in South Africa patented by Francois P. Cornish, U.S. Pat. No. 4,702,894. His system uses Aluminum, needing electrical energy from the coil on the engine to drive the reaction using the Hydrogen to fuel a small internal combustion engine rather than to power a fuel cell. Cornish method numbers show that he can generate hydrogen hydolyzing 9.7 grams of Aluminum wire per minute, enough Hydrogen to drive about 349 miles in a day assuming 1 kg of Hydrogen allows one to drive 25 miles. With May, 2006 prices of Aluminum, the cost per mile is $0.85, and fuel cost per day of constant Hydrogen generation is $297.44. The Aluminum cost is unrealistic economically.

“Hydrogen Refueling System Based on Autothermal Cycle Reforming” by General Electric—EER group of Ravi V. Kumar et al. reports using Nickel with Calcium Oxide and Calcium Carbonate to generate Hydrogen, which they then compress to feed to vehicles. It is one type of Hydrogen generator plant.

Compressed Hydrogen is not cheap either. Hydrogen can be produced with a commercial electrolyzer for about $10/kg in electricity costs. A small-scale production means may be in the $25/kg range. Used as fuel, as Cornish does, a kilogram of Hydrogen is about equal to a gallon of gasoline. At current prices, gasoline at $2.80/gallon has almost a four times price advantage.

The Department of Energy is still researching high temperature thermo-chemical reactions and other methods of Hydrogen generation for Hydrogen production distribution after it has been produced, not in situ production. University of Nevada, Las Vegas (UNLV) is researching fixed site Hydrogen production, not direct production in a vehicle. See: http://shgr.unlv.edu/report/STCH%20Quarterly%20Report%20004.pdf.

In the patent search for cold cracking Calcium, the only locatable Calcium purification for metallic Calcium products is in medical supplements for raising Calcium levels for strengthening bones. For reagent grade chemicals, the cost is about $150 per kilogram, which indicates there are some means of purifying this overlooked element, but either because of short run requirements or the process itself, it is not, under current practice, an economical end. Pfiser has a method of using Calcium carbonate—Aluminum bricketts and super heating them to about 1.500° C., to extract Calcium, which clumps on the walls as it condenses.

The Discovery: When using Hydrogen for fuel, whether feeding a combustion engine or fuel cell or other device, Calcium driven reaction with water may be the enabling means for in situ, generating it where it is being used. This reaction is spontaneous, starts itself, and continues to completion because Hydrogen gas exits the reaction medium. In contrast with most other alkaline metals, Calcium plus water is not explosive. It is the tortoise compared with Lithium, Sodium, Magnesium, and even Potassium.

Another marvel of Calcium is that its hydroxide, a strong base, converts quickly to carbonate with addition of Carbon dioxide forming Calcium carbonate, which precipitates as a sediment settling out of the water leaving the water clear and pH neutral. This second half of the discovery is applying the liquid bi-product of Hydrogen generation to removal of Carbon dioxide from major emitter situations as industrial stack gas, heavy vehicles' exhaust, and smoke from coal or other conglomerate fuel burn for power generation. The applications of these long known reactions are the discoveries. Both eliminate Carbon dioxide release in the atmosphere. Hydrogen burn gives water, not Carbon dioxide: and Calcium hydroxide devours Carbon dioxide from those polluting entities that must use Carbon Fuels from petroleum products to burning telephone books and newspapers, garbage, plant stalks and even crematorium outgases.

And to add to the economics of this discovery, the sediment, Calcium carbonate, can be sold to the cement industry to be part of the concrete that builds our roads and structures. It can also capture sulfates from smoke emissions. Because both systems output as an isolated, pure bi-product, clean, neutral pH water, collection systems are designed to capture this water. Theoretically, the yield from Hydrogen combustion is 9 kg of water generated from 63 kg Calcium. It can quench the vehicle occupants' thirst. This leaves sweet, clean air, clean water from both reactions, and solid footings from sales of the one solid bi-product.

Another use of the bi-product, either Calcium hydroxide or Calcium carbonate is a simple, effective, method of purifying Calcium metal and preparing the metal in consistent sized pellets for the purpose of generating Hydrogen gas onboard vehicles, making fuel available as one drives, flies or sails a Hydrogen powered vehicle.

The need has additionally arisen to provide a method of economical Hydrogen availability for fuel cells, some powering electric vehicles and some in permanent installations. Portable capability to provide this Hydrogen will enhance use of Hydrogen.

The need has additionally arisen to have Hydrogen fueled vehicles be serviced at conventional filling stations throughout the U.S. and around the world. With the designed Hydrogen distribution, the service station attendant can remove and replace three standard dimensional vessels in the Hydrogen fueled vehicle per every 400 or so miles driven. Instead of gassing up, one just removes empty Calcium and water vessels and provides full ones and removes the full Calcium hydroxide vessel and replaces it with an empty one and the vehicle is back on the road again. This is implemented by standard fuel plant design for Hydrogen powered vehicles, which is altogether possible with this technology. These spent vessels are then picked up and serviced and ones filled and ready to install are supplied to the filling station owner.

Additionally, the need has arisen to provide a safe and effective method of fueling a power need which uses available and unused power by power distribution companies and untapped natural energy generating situations as solar, wind, water movement and tidal sources that can tap the activity for power and store that power in pure metallic Calcium pellets to be used at a later date in whatever place it is needed. This is like an energy battery, but rather than releasing electrons, it releases Hydrogen molecules from water.

### DESCRIPTION OF FIGURES

FIG. 1—The in situ Hydrogen generator system—Chemistry.

FIG. 2—Details of the Hydrogen generator system—components

FIG. 3—Details of Hydrogen generator system—changes with motion.

FIG. 4—Details of Hydrogen generator system—handling Hydrogen.

FIG. 5—Side view Hydrogen Generator systems—post. Hydrogen generation

FIG. 6—Side view Hydrogen Generator system—start of Hydrogen generation.

FIG. 7—Carbon Dioxide Capture on truck exhaust.

FIG. 8—Carbon Dioxide Capture on truck exhaust with non-reverse valves.

FIG. 9—Hydrogen fuel piston system with crankshaft.

FIG. 10—Calcium Recovery by Hydrogen Reduction.

FIG. 11—Harvesting Calcium from Hydrogen Reduction.

FIG. 12—Installing a Hydrogen Generator in an Automobile.

FIG. 13—Installing a rack of Hydrogen Generators in a Truck.

FIG. 14—Installing a Hydrogen Generator in a stationary Fuel Cell unit.

FIG. 15—Sulfate capture using Calcium carbonate in Stack gas emission.

Starting with FIG. 16, a new numbering system is used rather than using three digits.

FIG. 16—The full cold cracking Calcium apparatus.

FIG. 17—Cryogenic getter and the movement and removal of the ice.

FIG. 18—The getter system with cold-transfer to the conveyor belts.

FIG. 19—The Calcium conveyor belt with steam hydrolysis of CaO.

FIG. 20—The Calcium conveyor belt with Electrolysis unit saturating Calcium molecules with Hydrogen reducing the molecule to Calcium metal and water caught by Cryogenic getter.

FIG. 21—The Calcium metal dust is dropped into the smelter where the Electrolysis output of Oxygen super-heats the fuel to melt the calcium into pellets taking place in an Argon/Hydrogen atmosphere.

FIG. 22—The details of Calcium pellet production is shown as one way pellet.

### THE METHOD

With the choice of Calcium metal as the Alkaline metal to free Hydrogen from water, we must realize that pure Calcium reacts instantaneously with water contact. Argon gas storage of Calcium prior to use keeps it fresh for rapid, but safe, reaction. The tooling and handling of these Calcium units must be smooth and reliable with little wasted motion to provide Calcium for the water exposure for smooth, continuous Hydrogen generation. Therefore, the Calcium form should be in pellets of common mass to reliably react with a measure of water to give a specific output of Hydrogen. The Calcium pellet will feed into a dispenser dropping into the water by gravity. This same principle will provide orderly feed to the Calcium managing the rate of Hydrogen generation.

The water supply of the unit is proportional to the mass of Calcium provided. Testing reagent consumption to reaction completion, the appropriate volume of water needed to process the Calcium mass is provided per Calcium infusion. The design of this solid unit defines dimension and components of the Calcium Hydrogen generating unit.

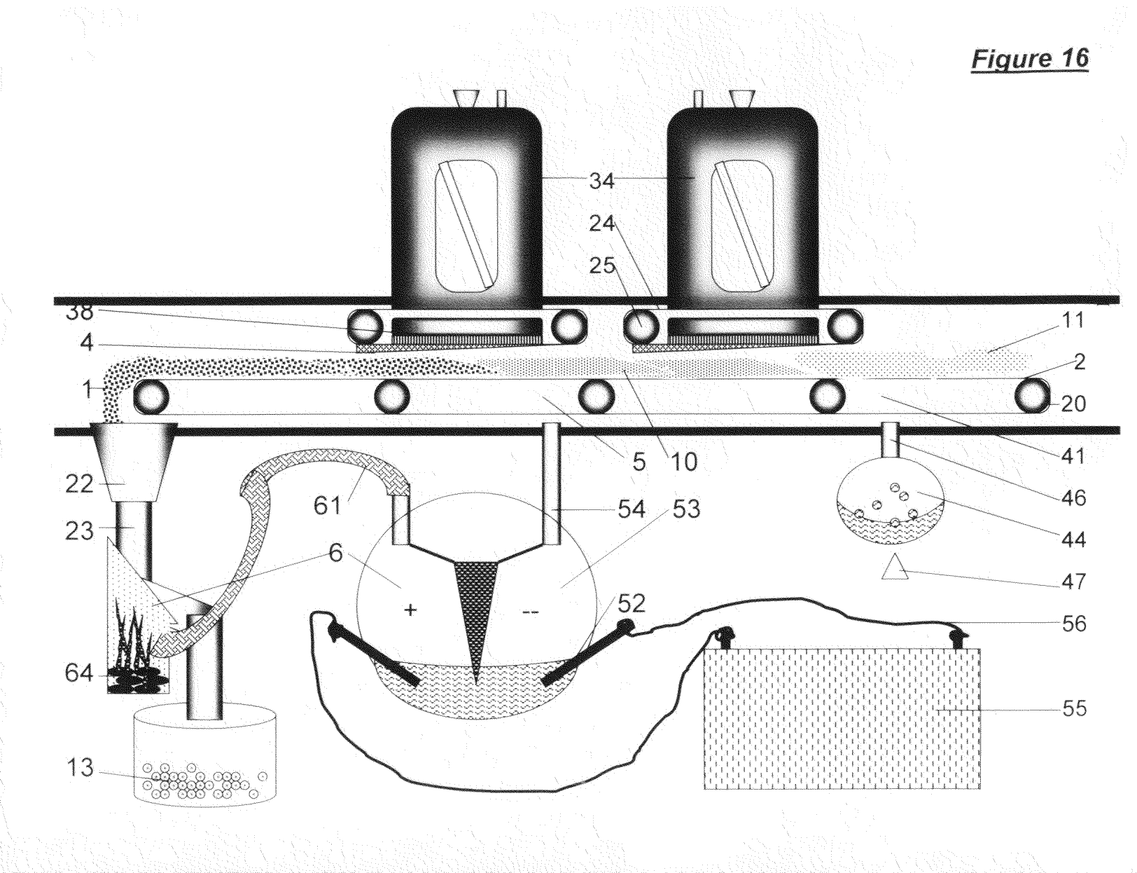

In practice, this unit will be a consistent one to another so the unit filled and ready to generate Hydrogen can replace a unit expended of water and Calcium. The expended unit will have containers of base, Calcium hydroxide, which will be transferred to equipment to capture Carbon dioxide and other chimney or exhaust pipe gases. This process will take another fixed form system replaceable as the Calcium hydroxide is expended. This process will convert Calcium hydroxide to Calcium carbonate. The Calcium carbonate will be reduced in a Reduction tube recovering metallic Calcium replenishing the process. Currently, Calcium metal is not a marketable metal. With reduction working, we can produce Calcium throughout the world where energy is generated locally as with water wheels or wind generators. Oxygen is a by-product of the process making it available for medical needs in these areas. This simplistic design is expanded in the final set of figures, FIGS. 16-22, showing an elaborate Cryogenic Calcium Cracking technique that can be used in electrical generating plants for power over capacity use, as would be the case from 2AM to 5AM, allowing this power to reduce Calcium hydroxide to metallic Calcium that can be sold for Hydrogen generation.

A Hydrogen piston engine design is shown where the Hydrogen forced the piston down, air or Oxygen is added and a spark converts it to water, which pulls the piston up.

Final figures show Hydrogen generating units in an automobile, a truck and a fixed fuel cell unit. These need service or replacement periodically depending on water and Calcium capacity and the rate of Hydrogen consumption by the fuel cell or motor.

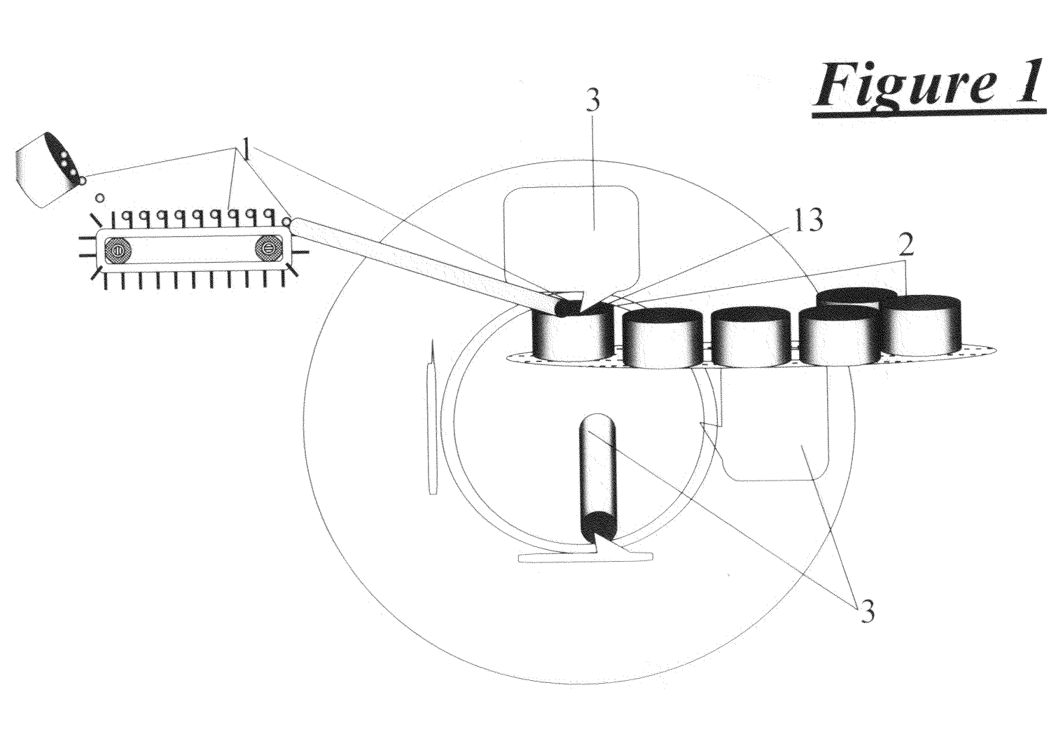

FIG. 1 shows the design of the in situ Hydrogen generator system 18 showing Calcium 1 is dropped in water 2 producing Calcium hydroxide 13 and Hydrogen 3.

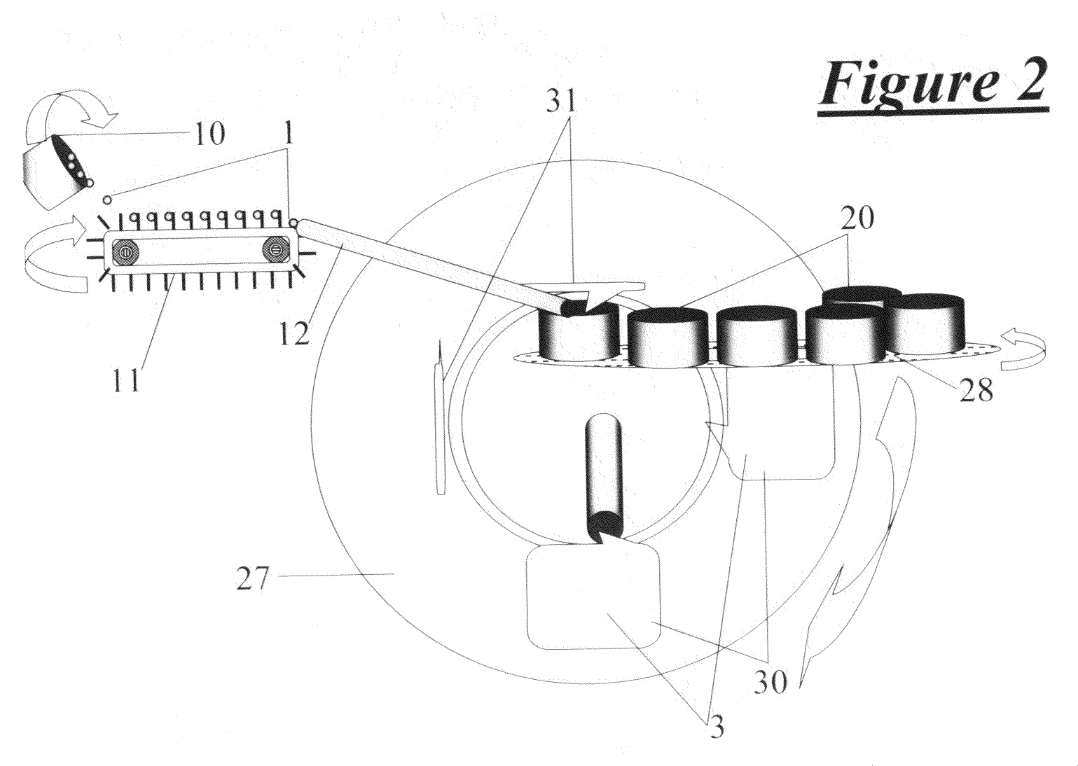

FIG. 2 shows the details of the Hydrogen generator with Calcium 1 being dropped from the Calcium receptacle 10 onto the Calcium conveyor 11 which passes the Calcium down the tube 12, which drops into the water receptacle 20 riding on the revolving disk 28. As Hydrogen is produced it inflates a bladder 30 as other bladders empty 31 in the tire-like unit 27 filled with liquid as water. Arrows show direction of motion of the Calcium receptacle 10. Calcium conveyor 11, the water disk 28, and tire-like unit 27 for capturing and releasing Hydrogen.

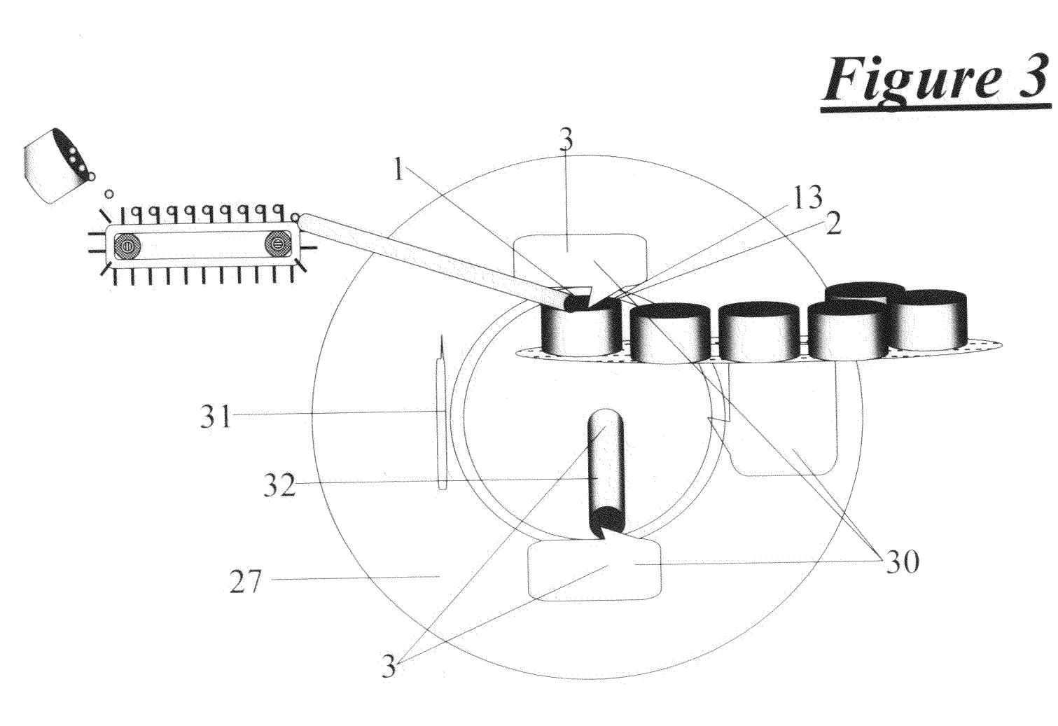

FIG. 3 shows the Hydrogen generator as the Calcium 1 hits the water 2. The Hydrogen bladder 30 is filling while Calcium hydroxide 13 forms giving off Hydrogen 3. Meanwhile, the lower Hydrogen bladder 30 is deflating emptying the Hydrogen into the tube 32 as the volume in the tire 27 remains the same.

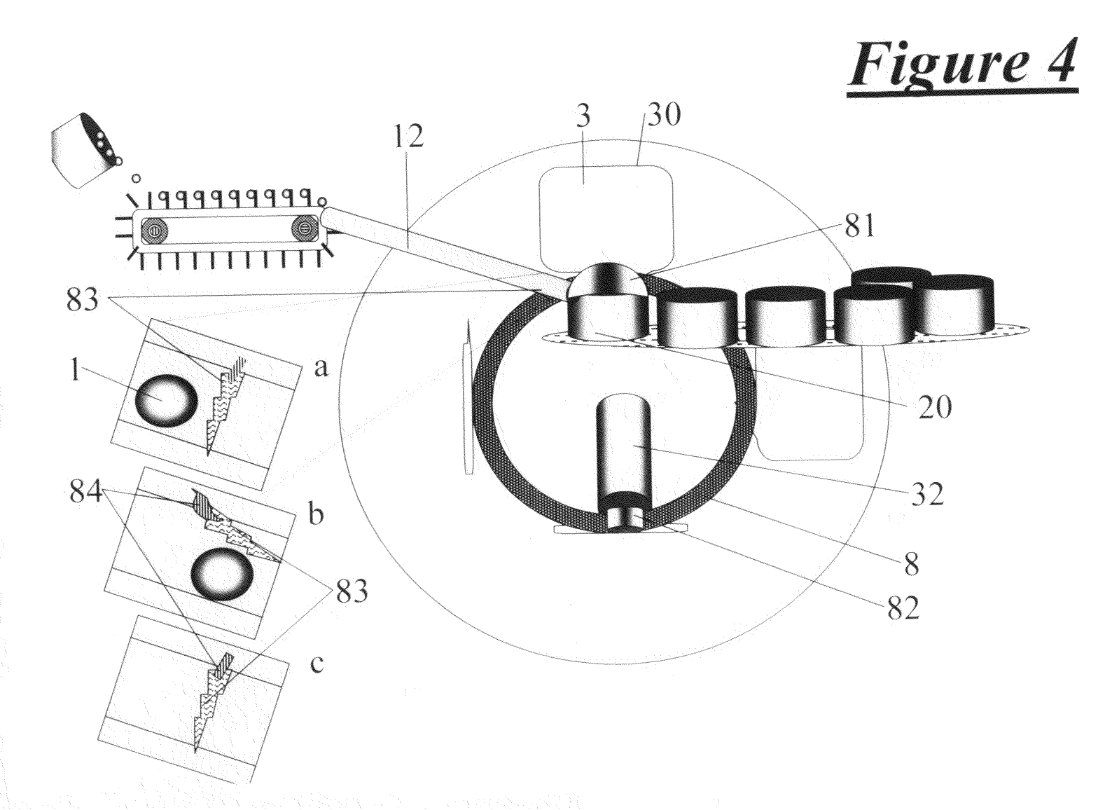

FIG. 4 shows the completion of the Hydrogen 3 generation with the Calcium hydroxide 13 reaction going to completion. The stationary inner cylinder 8 of the tire-like Hydrogen transfer unit is defined. Over the water container 20 in place to receive Calcium 1 is a funnel inverted to capture the Hydrogen 3 produced so it fills the sack 30. Opposite this funnel on the cylinder 8 is the tube to release the Hydrogen 82 from Hydrogen sack 31 shown collapsed. The Hydrogen, lighter than air, rises displacing other air components. Here it enters the Hydrogen tube 32, which leads to its use. Also defined is the valve 83 in the Calcium tube 12. It is held in place with a hinge 84, which allows the valve to open as the Calcium pellet 1 passes down the tube. It blocks some Hydrogen gas 3 passage. The Calcium pellet 1 progress passed the valve is shown in the sequence of three images, a, then b, and then c with it passed through the valve area.

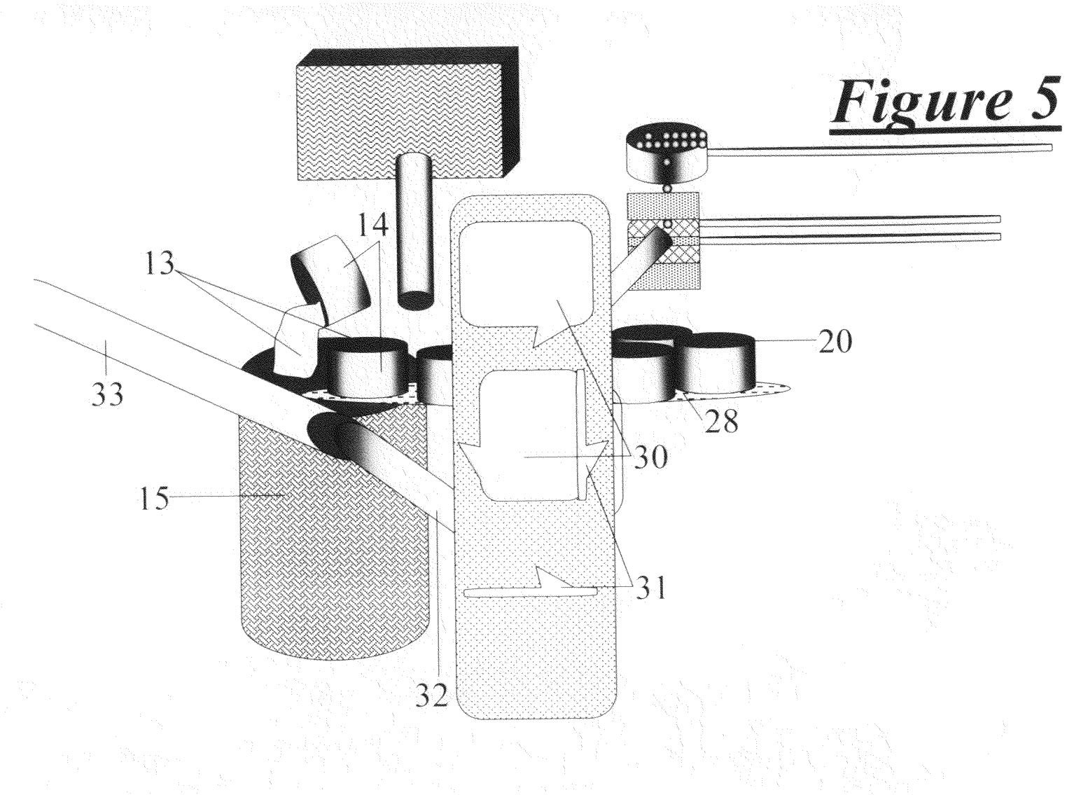

FIG. 5 shows the Hydrogen generator in side view with the water container 20 on the turning disk 28, the Hydrogen bladders full 30 and deflated 31, the Hydrogen tube 32 leading to the unit going to Hydrogen use 33. Also shown is the Calcium hydroxide 13 being emptied from the containers 13 into the Calcium Hydroxide reservoir 15.

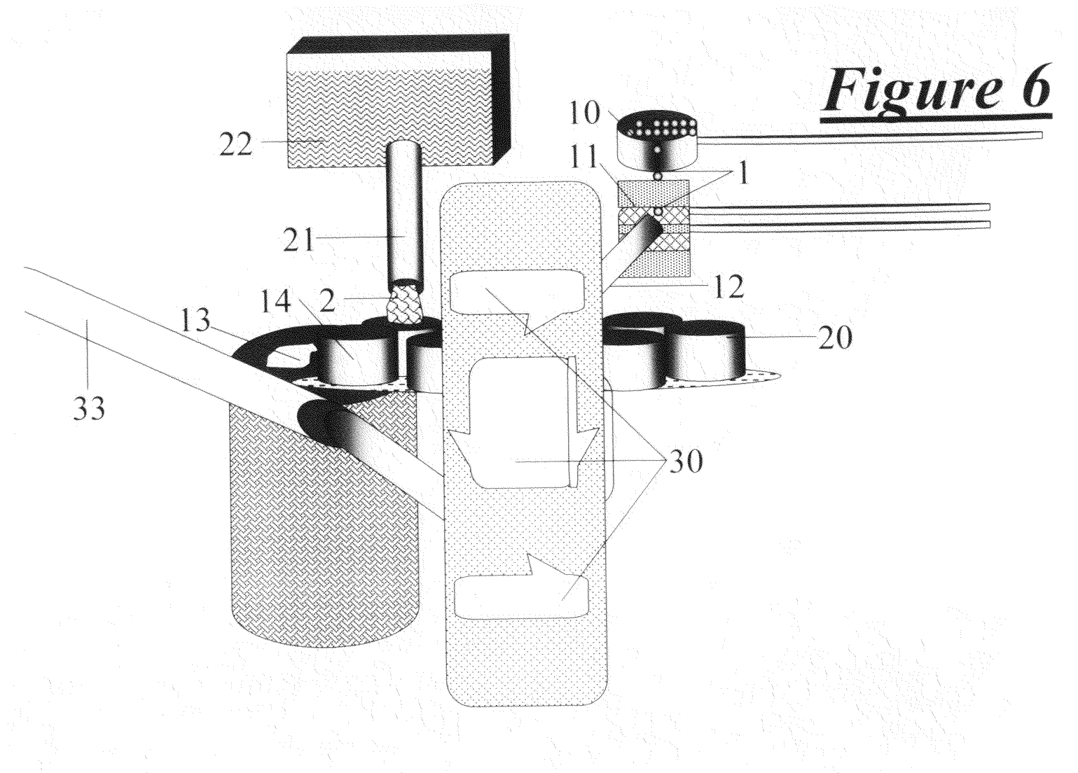

FIG. 6 shows the Hydrogen generator with container 14, once emptied filling with water 2 from the faucet unit 21 coming from the water reservoir 22. Also shown is the Calcium container 10 on the turning rod dropping Calcium 1 onto the conveyor 11 with two axels on the turning wheels so one pellet of Calcium at a time drops into the tube 12 and enters the water container 20 that is aligned with the tube 12. The Hydrogen bladders 30 are in flux with the top one filling while the bottom one empties directing Hydrogen to proceed onward to its immediate use 33.

This series should make the operation of the Hydrogen generator obvious to the reader/viewer.

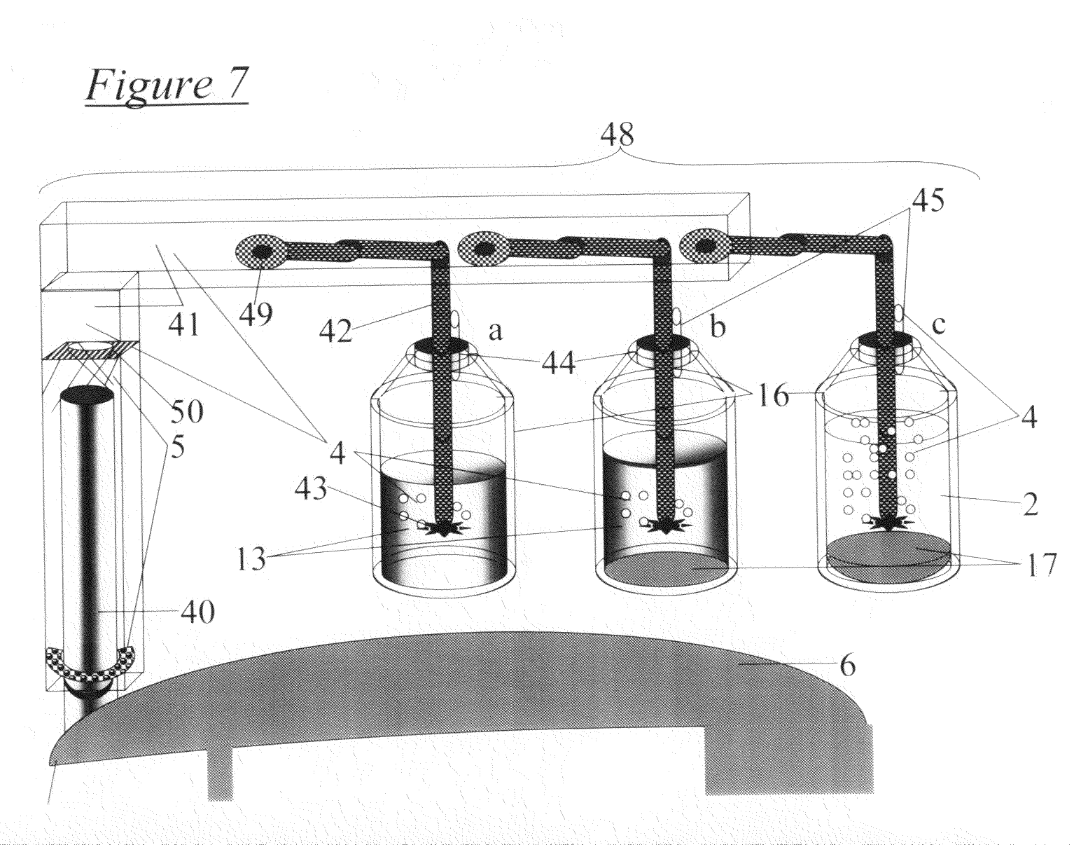

FIG. 7 shows a method of Carbon dioxide capture with a unit 48 built onto a truck 6 exhaust pipe 40. The manifold 41 has a filter 50 that knocks down the soot 5 and allows the Carbon dioxide 4 to pass through the manifold into the orifices 49 and down the tubes into the Calcium hydroxide 13 passing through the bubblers 43 to disperse the gas in small bubbles. A stopper 44 has a second hole for a release valve 45 allowing air to pass from the Calcium hydroxide containers 16. The reaction has the Calcium hydroxide 13 reacting with the Carbon dioxide 4 forming the precipitate Calcium Carbonate 17. When the reaction has gone to completion, there is only Calcium Carbonate precipitate 17 and water 2. Excess Carbon dioxide 4 passes through the water 2 and escapes out the tube 45. To capture more Carbon dioxide 4, new Calcium hydroxide vessels 16 must be put into place.

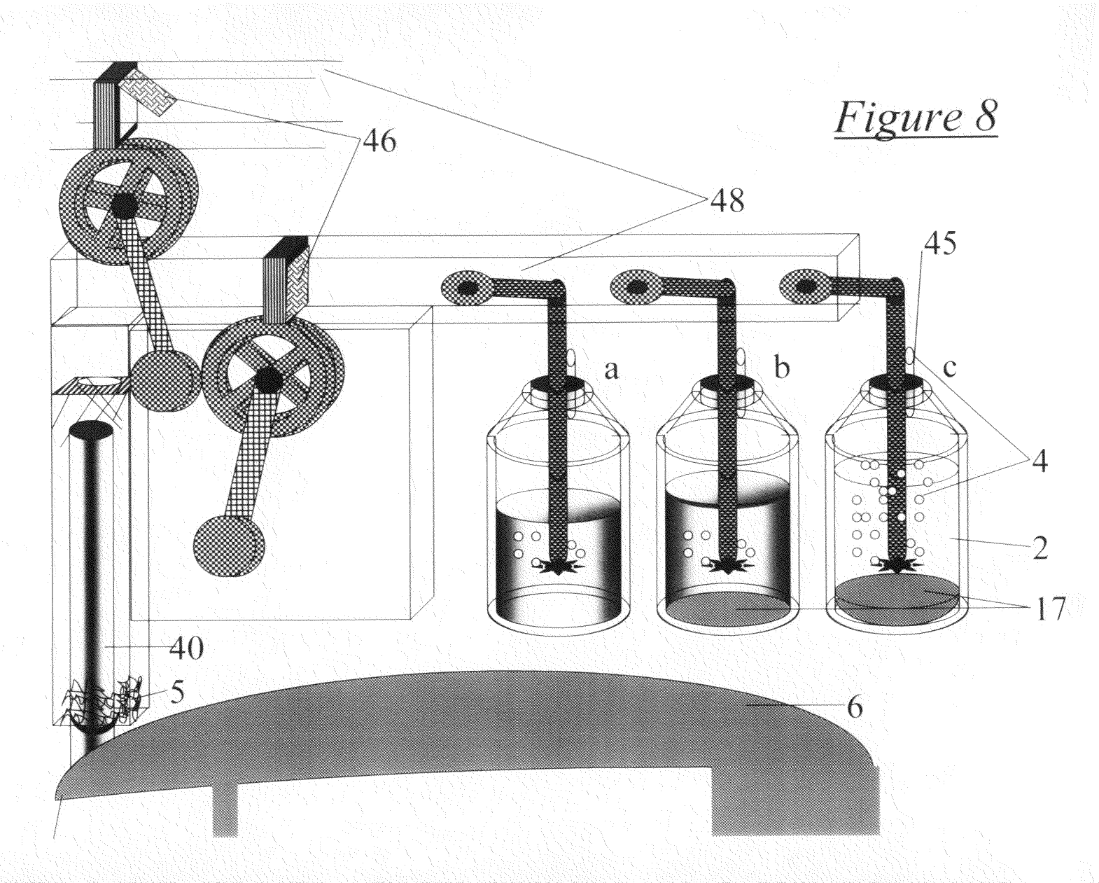

FIG. 8 shows the Carbon dioxide capturing system 48 with a valve pump system 46 insuring exhaust pipe 40 gases only pass one direction through the manifold 48. Two views of the valve system 46 are shown, one above the other. Soot 5 has accumulated at the bottom of the manifold.

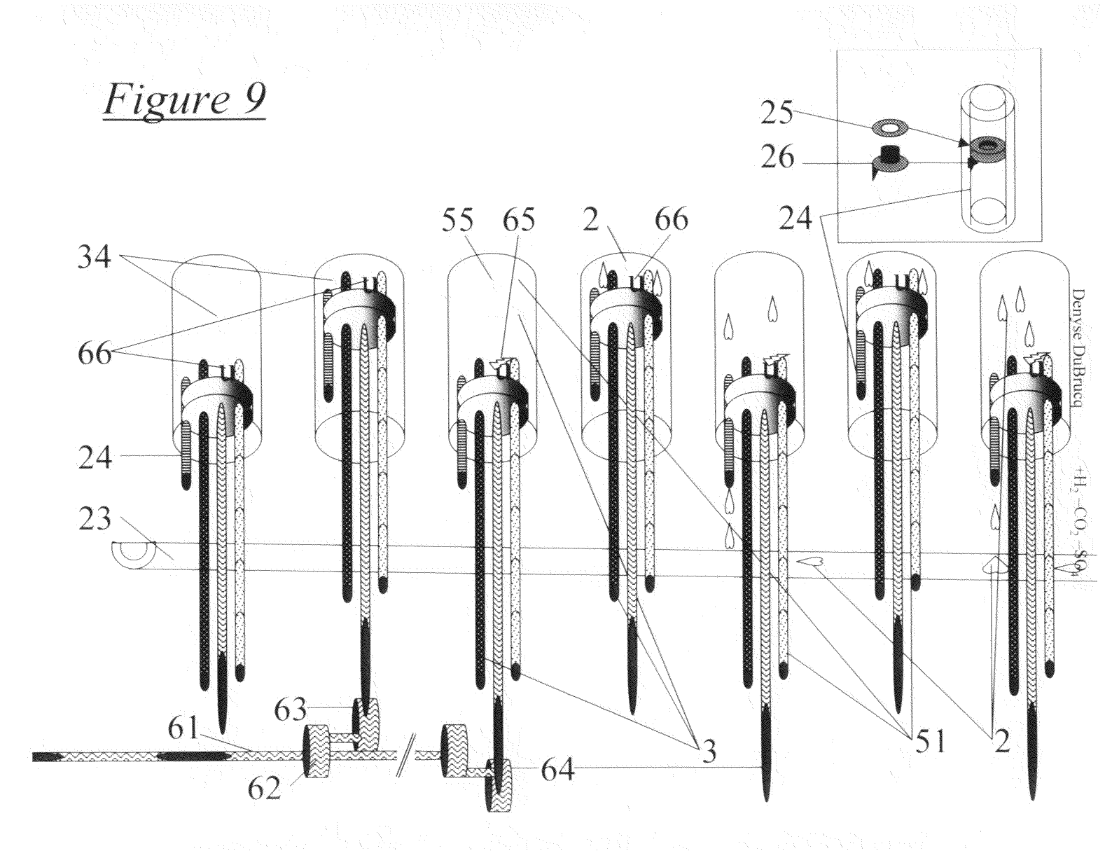

FIG. 9 presents a Hydrogen piston engine with a crankshaft 61 with cams 62 allowing off-center segments that move up 63 and down 64 as the pistons 34 fill with Hydrogen 3 the lower cam is forced down 64. Then air 55 enters the mix through the air intake 51 into the piston 34, the spark plug 66 sparks 65 igniting the Hydrogen air mix pulling the piston up 63 as water 2 forms from the explosion. It empties through the water tube 24 with the washer 25 and drip dispenser 26, which sends drops of water into the trough 23. This sequence of pistons 34 show the action of the cycle of burning Hydrogen 3 where only two of the pistons are shown with cam connections. These connections are part of every piston, and depending on how many pistons are used, that many are attached to the crankshaft cams. The row of pistons shows the reciprocating action.

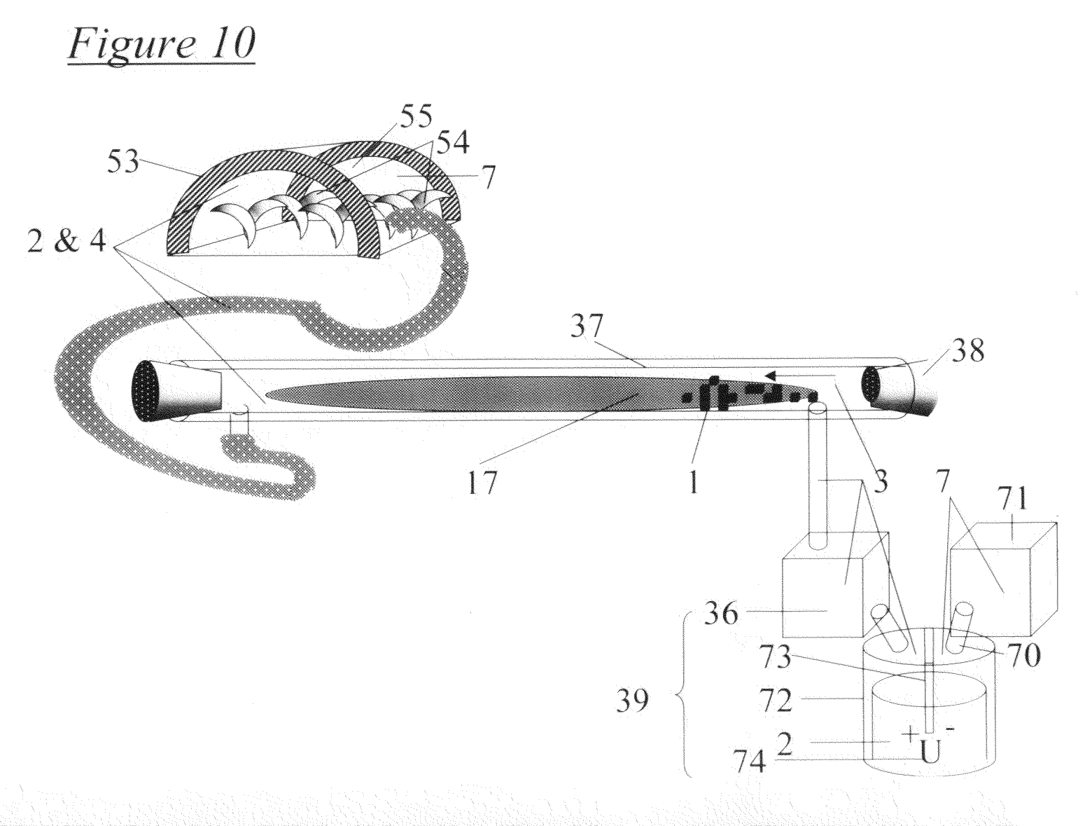

FIG. 10 shows reduction tube 37 purification of Calcium 1 using electrolysis 39 to generate Hydrogen 3 and Oxygen 7, which can be sold commercially for hospitals, breathing masks. The Electrolysis apparatus 39 has the electrolysis unit 74 in a vessel 72 with a divider 73 above the electrolysis unit separating the output from water of the gaseous Hydrogen and gaseous Oxygen. Oxygen passes through tube 70 into an Oxygen reservoir 71, from which it can be compressed into tanks for sale. Hydrogen passes into the Hydrogen reservoir—tube system 36 and can pass into the Reduction Tube 37. This has both entries into the tube on the bottom, the Hydrogen one low so Hydrogen 3 passes up, and the one on the far end of the tube low because the Carbon dioxide and water vapors are heavier than molecular Hydrogen. Stoppers 38 are on either end of the Reduction tube to allow filling it with Ca(CO3)₂ 17 and emptying out Calcium metal 3.

To reduce Carbon dioxide 4 release from the reduction reaction, the water 2 and CO₂ 4 is released in a lighted greenhouse 55 where the plants 54 photosynthesize the CO₂ into Oxygen 7. FIGS. 16-22 show a more elaborate Calcium purification method.

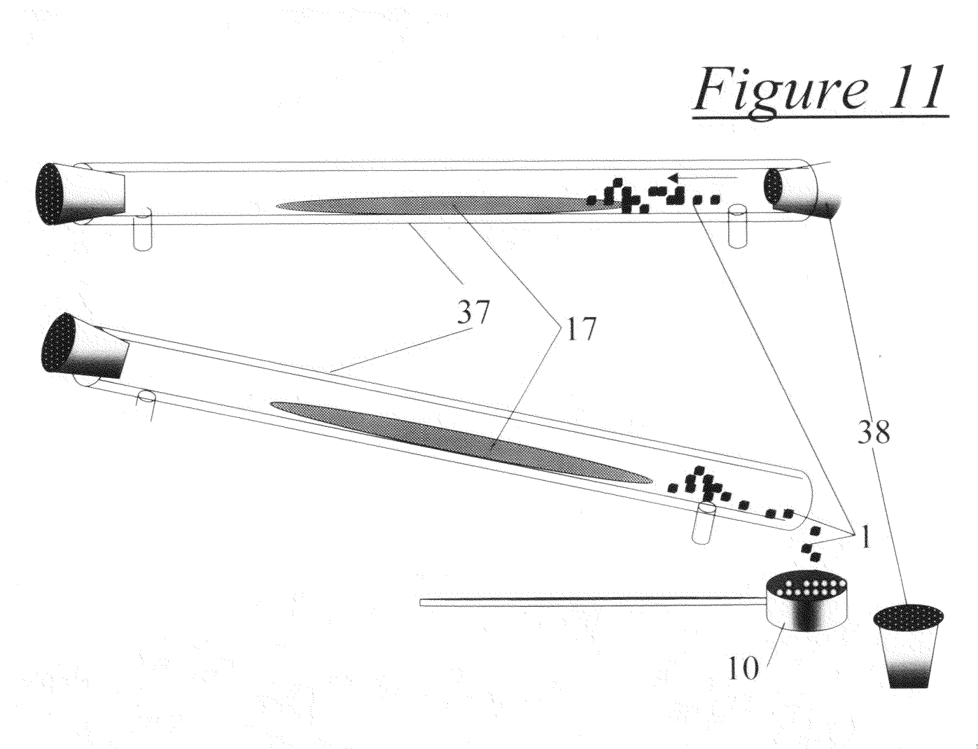

FIG. 11 shows Reduction tube 37 with some residual Calcium Carbonate 17 and a build up of Calcium chunks 1 being emptied of Calcium 1 by removing the stopper 38 on the Hydrogen entry end and filling the Calcium container 10 which then can be placed back in the Calcium Hydrogen generator 18.

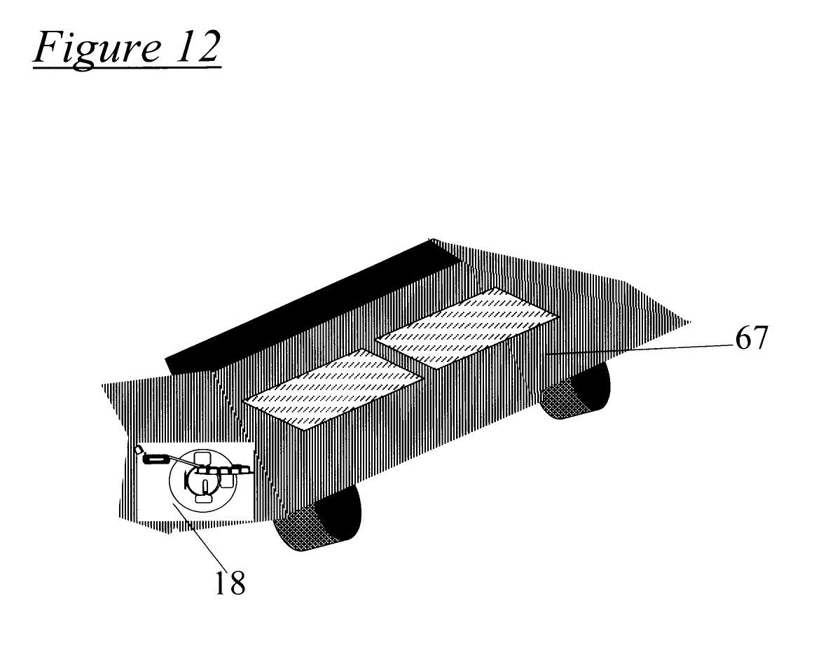

FIG. 12 presents an automobile 67 with a Calcium Hydrogen Generator unit 18.

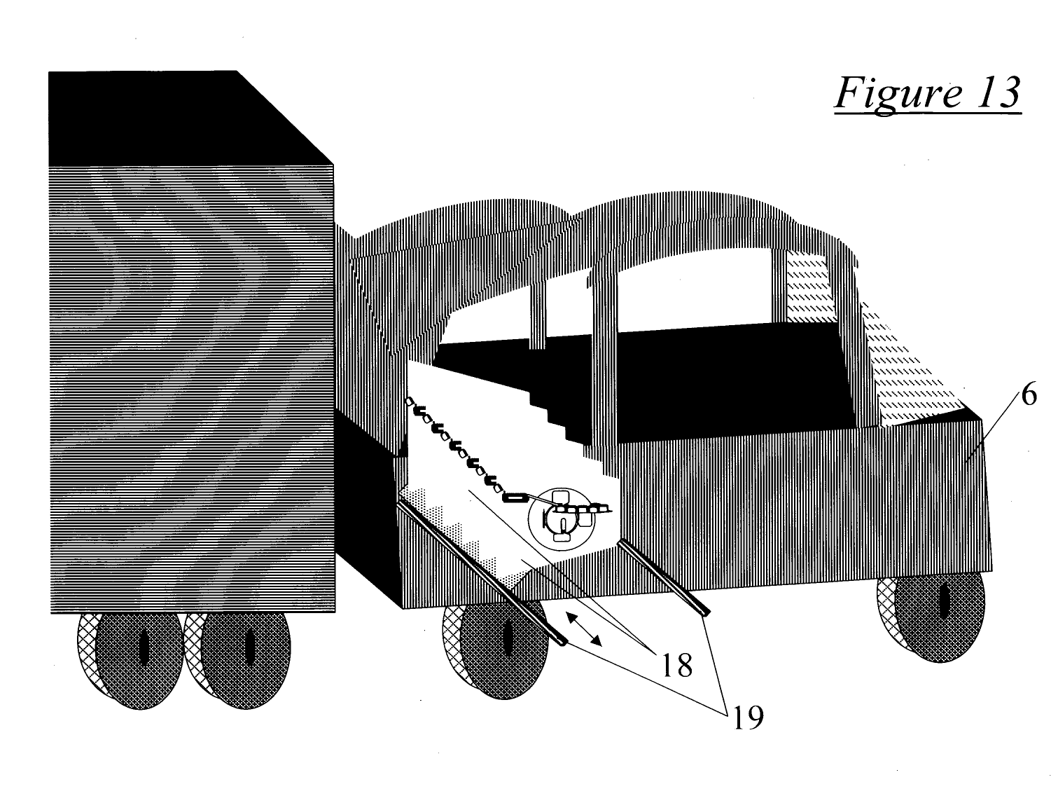

FIG. 13 shows a truck 6 with a series of Calcium Hydrogen Generator units 18 which can be serviced and/or replaced when drawn out of the truck on a rack 19.

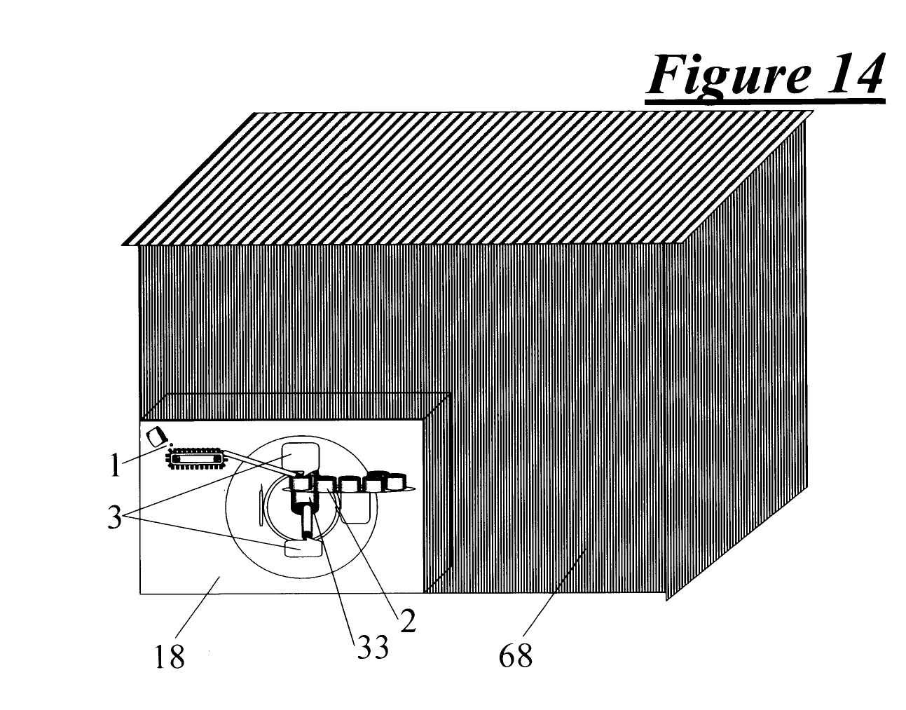

FIG. 14 shows a stationary fuel cell facility 68 with a Calcium Hydrogen Generator unit 18 and its chemicals, Calcium 1, water 2, and Hydrogen 3, and the tube taking the Hydrogen to its point of use 33, as fuel intake to fuel cell.

In practice, “filling stations” will have Calcium to fill the Hydrogen Generating System units. They will replace the Calcium hydroxide container with clean ones with appropriate water levels in the vehicles coming to the station. The Calcium hydroxide containers are turned over to the servicing group, who will transfer the Ca(OH)₂ reaction bottles to the Carbon dioxide catchers and replace them with empties. The gas station attendants will put the water in the system units once they are installed in the automobiles and other vehicles and will put the water in the water reservoirs of system units before pushing the rack back in trucks. Calcium will feed into these units as Hydrogen is needed to propel the vehicles. Used systems are returned to the service location. These closed systems are safe. Any mess will be cleaned up in the recycling process of the systems unit. If the Calcium reservoir is pierced, determined by a test as to its ability to hold increased air pressure, that unit will be disposed of before any Calcium or water is added to the unit.

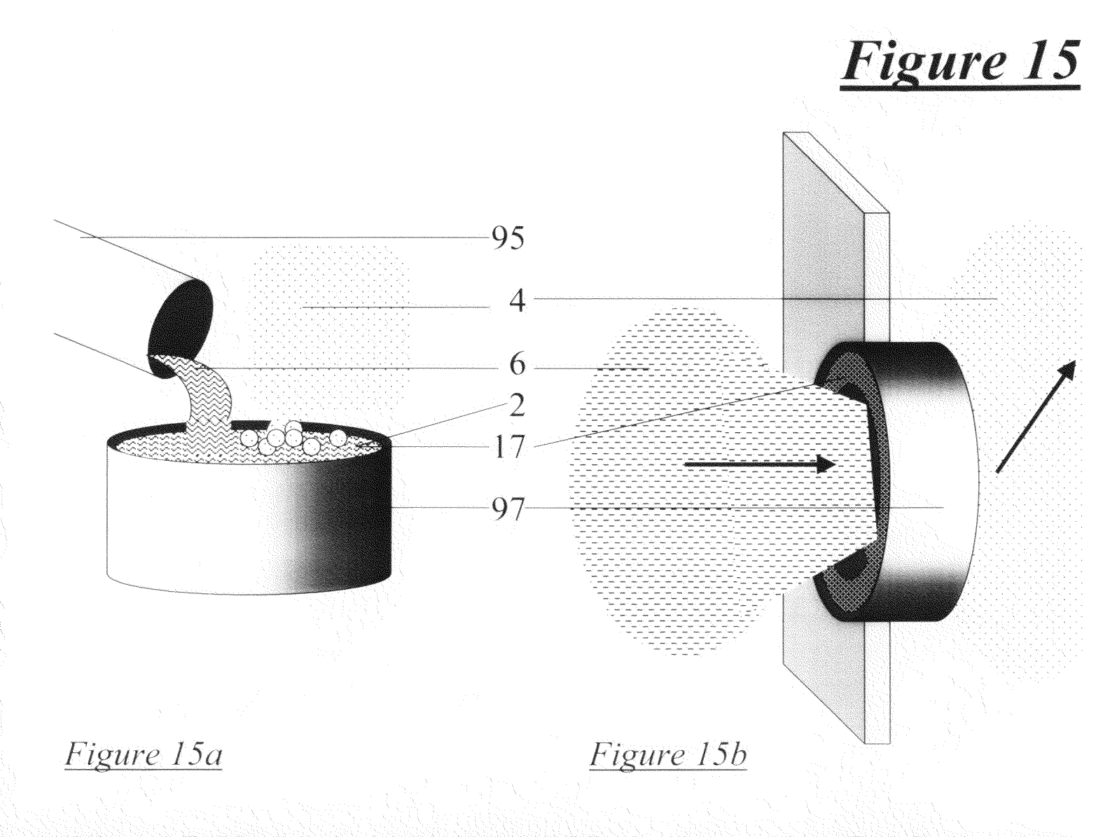

FIG. 15 shows capture of sulfates by carbonate replacement and sulfites with Calcium oxide/Calcium hydroxide in such an apparatus. These are useful in smoke stack scrubbers. If the burn is heated with Oxygen enhanced air, it converts the characteristic sulfites in smoke to sulfates. These sulfates would create acid rain, but if captured using the precipitate Ca(CO₃)₂ 17 held in containers 97, the sulfates 6 in container 95 combine with Calcium replacing the two carbonates 4, which in 15a bubble up in water solution 2. In air, 15b, this same reaction will release the Carbon dioxide 4 into the air and to be used in the air exchange with photosynthesis as plants release Oxygen when in light.

Oxygen can be supplied by having Liquid Nitrogen generation done in close proximity to the smoke stack. The Calcium Carbonate is available from the exhausted precipitate caused by running truck exhaust through Calcium hydroxide from converting a water-Calcium mix to Calcium hydroxide and Hydrogen. This would be one more procedure in the Stack Gas Scrubber invention described in DuBrucq's May 17, 2007 filing, Liquid Nitrogen Enabler Apparatus, application Ser. No. 11/750,149. It provides a use of the by-product. Calcium carbonate, from this Hydrogen generation.

FIG. 16 through 22 define an elaborate Calcium cracking system that takes advantage of the reversibility of the Ca+H₂O⇄H₂+Ca(OH)₂ reaction where normally the Hydrogen goes flying off into the stratosphere, but here we flood the Ca(OH)₂ with Hydrogen and the water is captured by the cryogenic getter system and conveyed out of the system leaving the desired Calcium metal dust. This is then melted into pellets.

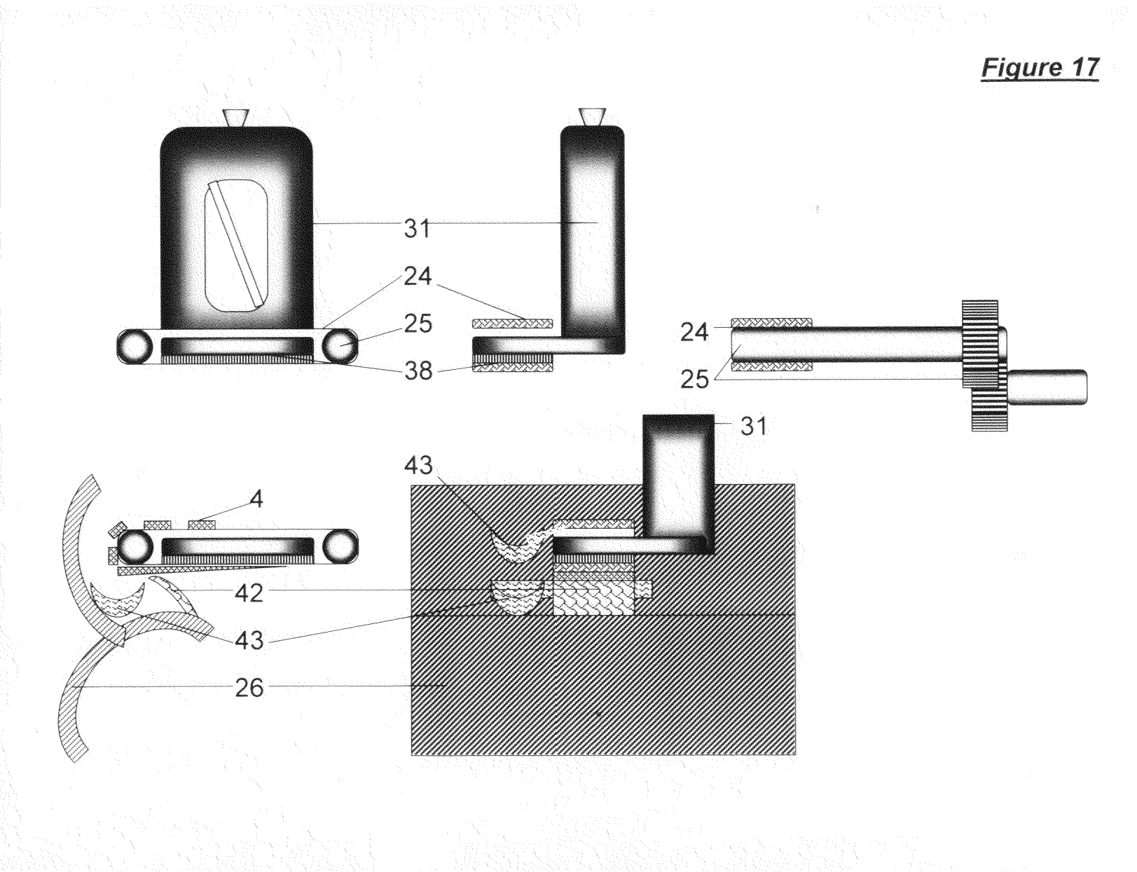

FIG. 16 illustrates the entire Cryogenic Calcium Cracking system with Calcium oxide 11 on conveyor 2 moved by rods 20 undergoes exposure to water vapor steam 41 emerging from a heated 47 flask of water 44 with the neck 46 spewing the steam to react with the Calcium oxide to form Calcium hydroxide 10. As the conveyor 2 progresses, the Calcium hydroxide 10 encounters Hydrogen gas 5 emerging from tube 54 leaving the Electrolysis chamber 53 where the electrode 52 releases the Hydrogen 5 because of the direct current electricity entering from battery 55 via wire 56. This emerging Hydrogen reacts with the Calcium hydroxide in a Hydrogen atmosphere reducing it to Calcium metal 1 and releasing water vapor, which sublimes into ice 4 on the cold getter conveyor 38. The getter units 34 are filled with cryogenic Liquid Nitrogen taking the temperature of the getter surface to minus 196° C. To remove the ice 4 from the system, conveyors 24 are drawn right to left by the rods that turn pulling the cryogenically cold conveyor 24 and as they curve up out of the chamber, the ice breaks off and is removed from the reaction pulling the Calcium hydroxide plus Hydrogen reaction towards the resulting water which is removed as ice plus Calcium metal. The calcium metal dust 1 drops off the end of the conveyor belt 2 into an Argon atmosphere entering the hopper 22 and going down a pipe 23 into a heated area 64 to over 854° C. so as to melt the Calcium dust into liquid Calcium by enriching the fuel with Oxygen 6 coming from the Electrolysis unit via tube 61. The melted Calcium hardens into Calcium pellets 13 of common mass, shape and size. The following figures, FIGS. 17-22, define specific parts of this process.

FIG. 17 shows in the top row of images the cryogenically cooled getter 31 with the conveyor belt 24 moved on rods 25 and cooled by contact with thermal conducting metal brushes 38 in front and side views. On the right is the rod driver unit 25 moving the conveyor belt 24. Below shows ice 4 removal from the conveyor with a pressure unit 42 to fracture the ice and a trough 43 to catch the ice along with the curved configuration of the walls 26 of the Calcium Cracking unit. The trough 42 contains the ice and as it melts into water, it flows out of the system. As it leaves the ice catch area, it is covered so the water doesn't vaporize and contaminate the reaction in the chamber reversing the chemical reaction desired by contaminating the Calcium metal into Calcium hydroxide.

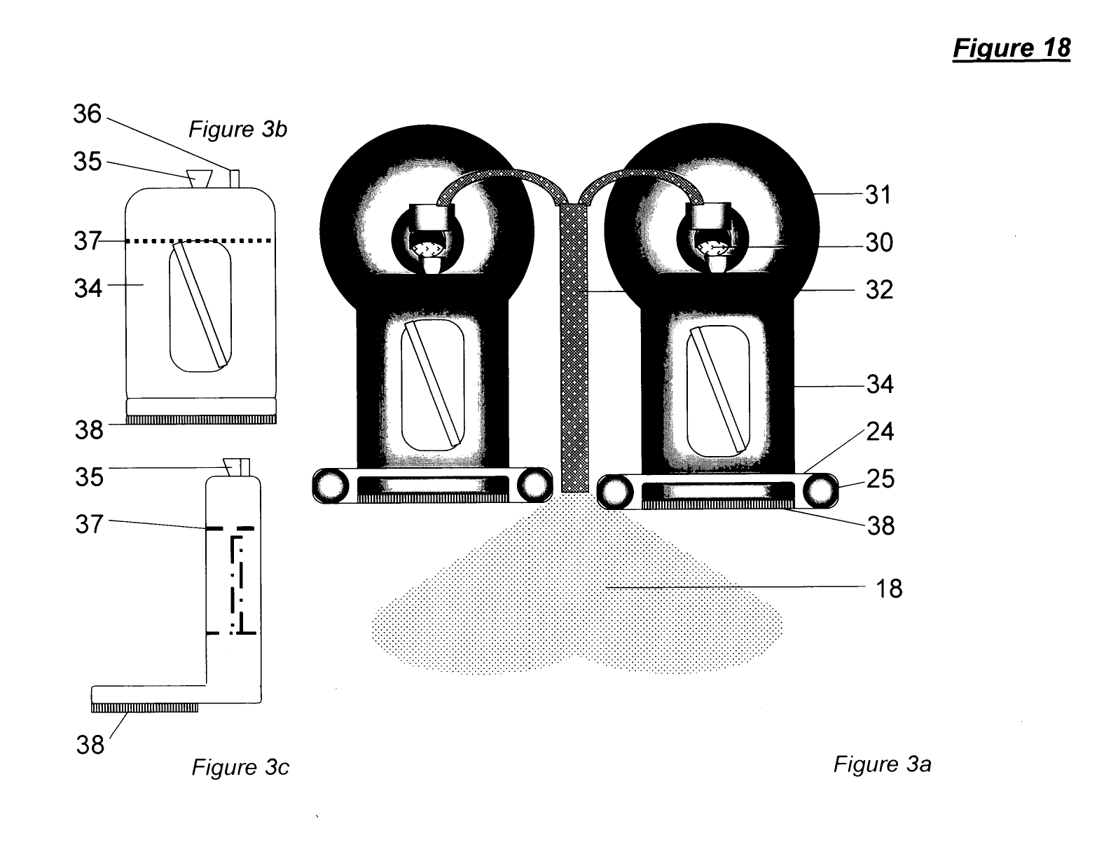

FIG. 18 shows the getter structures 34 fed from cylindrical dewars 31 pouring cryogenic liquid 30, either Liquid Argon at −185.88° C. or Liquid Nitrogen at −195.95° C., into the getter unit 34 through its filling nozzle 35. If Liquid Nitrogen is used, the gaseous Nitrogen is out-gassed in the air. If Liquid Argon is used, as shown in FIG. 18, the Argon gas 18 is out-gassed into the Calcum Cracking Chamber. If Liquid Nitrogen is the coolant, then Argon compressed gas is used to fill the chamber. The Cryogenic gas release tube 36 releases the Argon 18 into the Chamber. The foot of the Getter has the conducting brush 38 attached under it to transfer the cold to the lower part of the conveyor belt 24 that is moved with rods 25. For maximum cooling by the liquid cryogen, inside the getter 34 is a sieve 37 breaking the cryogen into droplets that evaporate as they fall flooding the getter base and foot with super cold cryogenic gas making the temperature of the brush 38 at or around −180° C.

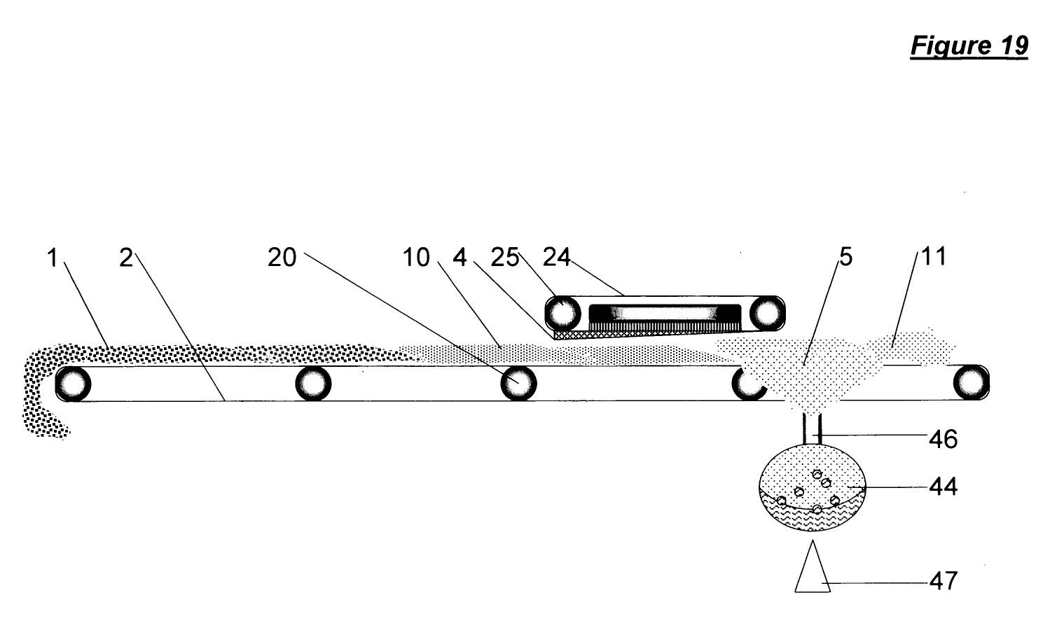

FIG. 19 illustrates the conveyor systems. First, as previously shown, the getter conveyor belt 24 cooled by the getter, turned on the rods 25 and collects ice 4 by pulling the water produced by Calcium hydroxide reduction out of the chamber atmosphere. Second, the Calcium conveyor belt 2 is driven by rods 20 and carries, as it is converted Calcium oxide 11, then Calcium hydroxide 10, and finally Calcium metal 1 which falls off the belt as it progresses. Also shown here is the hydration of Calcium oxide with a heated 47 flask 44 with a neck 46 releasing water vapor 5 onto the Calcium oxide 11, converting it to Calcium hydroxide 10. There are two getters in the system. This first one, with the belt 24 and rods 25 shown here, condenses or sublimes the excess water vapor from the flask 44 into ice 4 beyond what is needed to hydrate Calcium oxide.

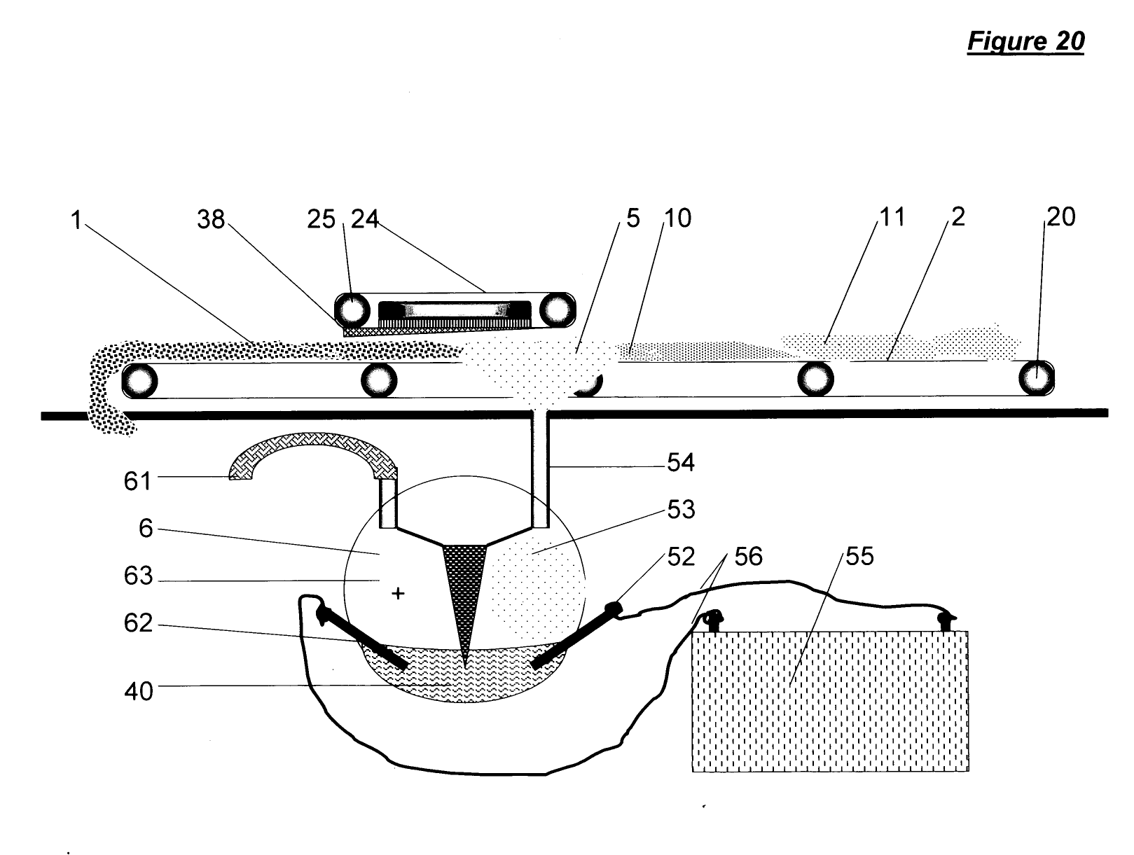

FIG. 20 shows the Electrolysis unit outside of the chamber with the Hydrogen feed 54 entering the chamber from the bottom flooding the chamber with Hydrogen 5. The Hydrogen side of the Electrolysis flask 53 is filled with direct current charge from the electrode 52 as it is immersed in water 40. Both electrodes are powered from battery 55 by leads 56. The electrode 62 liberates the Oxygen 6 in the Oxygen side of the flask 63, and the Oxygen is released through the tube 61 to its use or storage point.

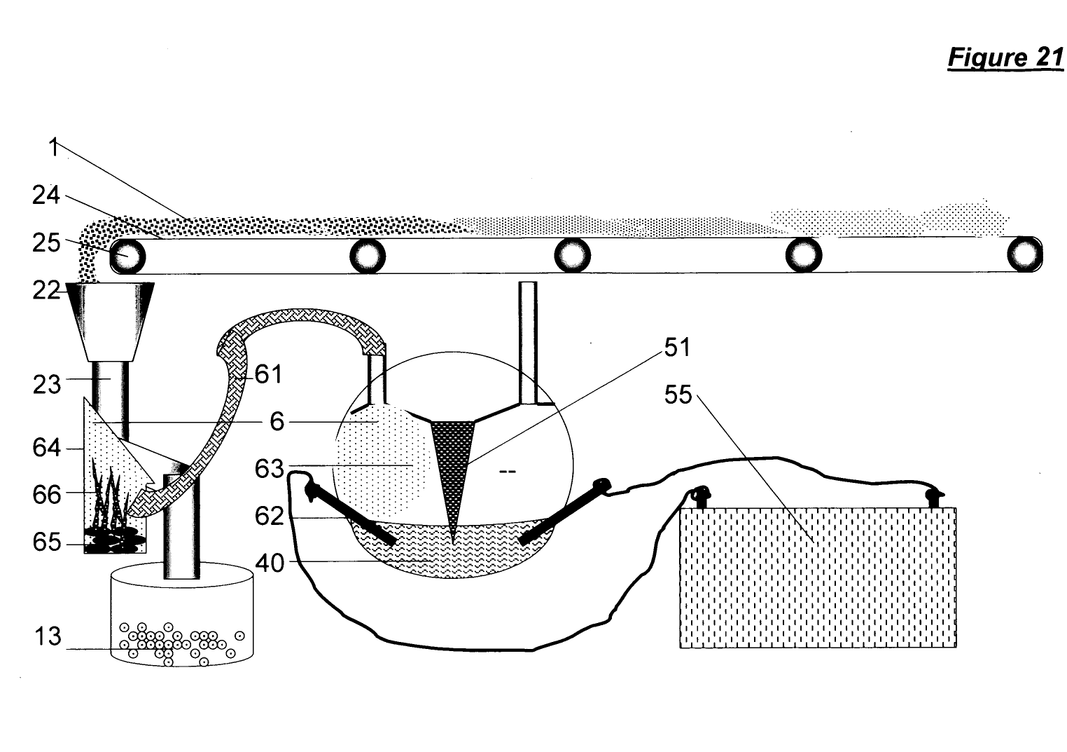

FIG. 21 shows the smelter where the Calcium dust 1 falls from the conveyor belt 24 into the funnel 22 which passes it down the tube 23 to the smelting area where the furnace 64 has fuel 65 burning with flames 66 with its heat enhanced by the Oxygen 6 generated in the Electrolysis process. The output is Calcium pellets 13 collected below the final tube segment. One detail in the Electrolysis flask is the divider 51, which extends into the water and up to sealing to the tubes carrying away respectively Hydrogen and Oxygen. The sides are sealed to prevent mixing of gasses, an established practice.

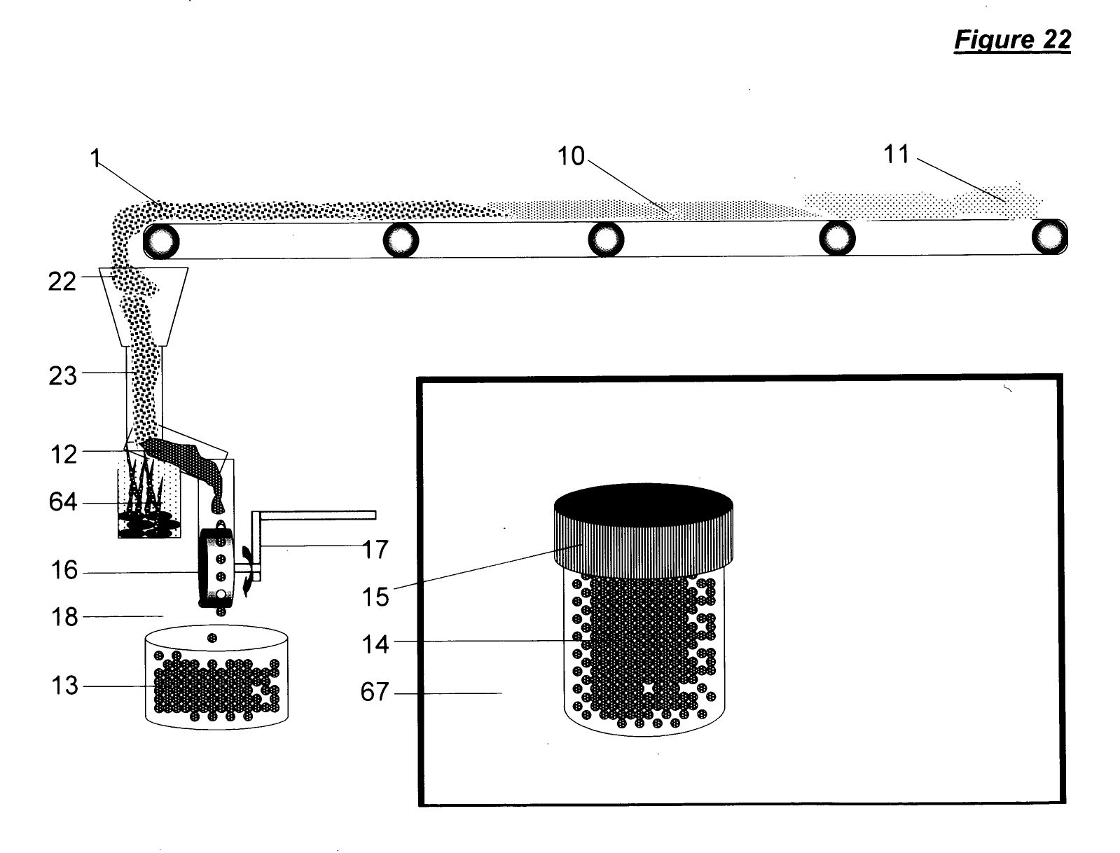

FIG. 22 details the pelletization of the Calcium dust 1 showing the molten Calcium 12 leaving the furnace location 64 in an Argon atmosphere 18, dropping on the mold wheel 16, which turns with a crank 17 mechanically or automatically. The pellet 13 is released as the molten metal solidifies into pellets 13. In the Argon atmosphere, the pellets are placed in ajar 14 with a secure top 15 and is stored in normal air atmosphere 67. In reagent shipments of Calcium metal, they dip the delivery container in wax to prevent leakage at the seal between the jar and the top. This jar 14 will be mounted in the vehicle or other Hydrogen fuel device to supply the Calcium pellets for on-board Hydrogen production . . . see FIG. 1-6.

Therefore we claim:

1. A method of Hydrogen generation whereby metal calcium is added to water instantaneously forming Hydrogen molecule and Calcium hydroxide in an apparatus that:
a. advances the water container to location where Calcium is added,
b. captures the Hydrogen in a bladder in a liquid environment above the reaction,
c. moves Calcium hydroxide, depositing it in a reservoir, and replacing it with water,
d. has multiple liquid containers and in a conveyor type configuration, and,
e. repeats this process at the rate the Hydrogen is required for the use intended.

2. The method, according to claim 1, that produces Hydrogen at the site of use at the rate required eliminating storage of gaseous Hydrogen.

3. The method, according to claim 1, where Calcium, water, and the empty receptacle for Calcium hydroxide are common dimension, common attachment vessels fitting all Hydrogen powered vehicles and fixed base units allowing filling stations and delivery services to exchange refilled vessels for expended ones safely and efficiently.

4. A method of capturing Carbon dioxide by passing stack gas or vehicular exhaust gas through a processor that:
a. contains Calcium hydroxide which reacts with Carbon dioxide by releasing water and replacing it with two radicals of Carbonate,
b. neutralizes the base pH of Calcium hydroxide,
c. precipitates the Calcium carbonate, and
d. produces potable water.

5. The method, according to claim 4, which reduces the Carbon dioxide emissions from known billowing sources of Carbon dioxide as industrial smoke stacks and truck and construction vehicle exhaust pipes.

6. The method, according to claim 4, whereby Carbon dioxide in the atmosphere can be reduced by capture with Calcium hydroxide.

7. A method of Cold Calcium Cracking using a reduction chamber in which
a. Electrolysis or other method generates Hydrogen, which passes over Calcium hydroxide reducing it to Calcium metal with water as byproduct;
b. Calcium metal is kept from reaction by eliminating the water from the chamber atmosphere with cryogenic getters and flooding the chamber with Hydrogen gas;
c. the ice on the cryogenic getters is removed from the reduction chamber, melts into water, and flows out of the chamber and used as desired.

8. The method, according to claim 7, allows Calcium metal to be an energy storage material using the energy produced at the purification site and releasing that energy in the form of Hydrogen used in the engine or at the fuel cell location.

9. The method, according to claim 7, where energy generation can be transported from creation site to a use site independent of any connection as electric wires, pipelines, through the movement of the pure Calcium to the location or on board a vehicle where it generates pure Hydrogen serving as fuel or energy.

10. A method of burning Hydrogen in a piston engine whereby the power thrust is pulling the piston rod into the piston with the ignition of Hydrogen gas combining with Oxygen forming vapor or droplets of liquid water of considerably lesser volume.

11. The method, according to claim 10, whereby Carbon dioxide in the atmosphere is further reduced by substituting Hydrogen for petroleum or organic based fuels having rather than the Carbon dioxide as the exhaust material, it expels pure water, which is captured and used.

12. A method of removing sulfur compounds from smoke and polluted waters by making Calcium base or precipitate available to capture the sulfur component.

13. The method, according to claim 12, of sulfate capture using the by-product of Carbon dioxide capture, Calcium carbonate, a precipitate, in
a. high sulfate content gas masses or
b. dissolved in water
where the sulfate replaces the carbonate giving off Calcium sulfate and Carbon dioxide which is absorbed by plants in light, exchanging it for Oxygen.

14. The method, according to claim 12, of sulfite capture using the by-product of Hydrogen generation, Calcium hydroxide, an alkaline base, in
a. high sulfite content gas masses, or,
b. dissolved in water
where the sulfite replaces the hydroxide radical producing water and Calcium sulfite.

15. The method, according to claim 12, of sulfur capture using the by-product of Hydrogen generation, Calcium hydroxide, an alkaline base in
a. high sulfur smoke or
b. dissolved in water
where the sulfur replaces the hydroxide radical producing water and Calcium sulfide.
